(19) United States
(12) Patent Application Publication
(10) Pub. No.: US 2013/0281188 A1
(43) Pub. Date: Oct. 24, 2013

(54) PRESENTING LIVE CASINO MEDIA FOR ONLINE GAMING

(71) Applicant: WMS GAMING, INC., Waukegan, IL (US)

(72) Inventors: Andrew C. Guinn, Chicago, IL (US); Travis N. Nelson, Canton, GA (US); Richard B. Robbins, Glenview, IL (US); Richard T. Schwartz, Deerfield, IL (US); Tracey L. Wright, West Chicago, IL (US)

(21) Appl. No.: 13/797,551

(22) Filed: Mar. 12, 2013

Related U.S. Application Data
(60) Provisional application No. 61/635,001, filed on Apr. 18, 2012.

(51) Int. Cl. G07F 17/32

(52) U.S. Cl. CPC G07F 17/323; G07F 17/3244
USPC 463/25; 463/42

(57) ABSTRACT

Some embodiments include a method for enabling online wagering game players to receive, while playing online wagering games, live media feeds of activities in a casino. The method can include presenting a graphical user interface including an online gaming interface and a live casino interface, wherein the online gaming interface includes lifelike computer-generated images of a wagering game machine having a display device, and computer-generated images of game elements for an online wagering game, where the game elements appear on the wagering game machine's display device. The method can also include receiving a first media feed including audio and video content portraying activities in a live casino, and presenting the media feed in the live casino interface.

### RELATED APPLICATIONS

This application claims the priority benefit of U.S. Provisional Application Ser. No. 61/635,001 filed Apr. 18, 2012.

### LIMITED COPYRIGHT WAIVER

A portion of the disclosure of this patent document contains material which is subject to copyright protection. The copyright owner has no objection to the facsimile reproduction by anyone of the patent disclosure, as it appears in the Patent and Trademark Office patent files or records, but otherwise reserves all copyright rights whatsoever. Copyright 2013, WMS Gaming, Inc.

### FIELD

Embodiments of the inventive subject matter relate generally to wagering game systems, and more particularly to presenting media from live casinos as part of online wagering game sessions.

### BACKGROUND

Wagering game machines, such as slot machines, video poker machines and the like, have been a cornerstone of the gaming industry for several years. Generally, the popularity of such machines depends on the likelihood (or perceived likelihood) of winning money at the machine and the intrinsic entertainment value of the machine relative to other available gaming options. Where the available gaming options include a number of competing wagering game machines and the expectation of winning at each machine is roughly the same (or believed to be the same), players are likely to be attracted to the most entertaining and exciting machines. Shrewd operators consequently strive to employ the most entertaining and exciting machines, features, and enhancements available because such machines attract frequent play and hence increase profitability to the operator. Therefore, there is a continuing need for wagering game machine manufacturers to continuously develop new games and gaming enhancements that will attract frequent play.

### BRIEF DESCRIPTION OF THE FIGURES

Embodiments of the invention are illustrated in the Figures of the accompanying drawings in which:

FIG. 1 is a conceptual diagram illustrating an online gaming interface, according to some embodiments of the inventive subject matter.

FIG. 2 is a conceptual illustration of an online gaming interface presented with a live casino interface.

FIG. 3 is a conceptual illustration in which a live casino interface includes media showing people moving about a casino.

FIG. 4 is a conceptual diagram illustrating multiple views for the online gaming interface and live casino.

FIG. 5 shows yet another embodiment in which the online gaming interface presents multiple views of players in a live casino.

FIG. 6 is a block diagram illustrating a wagering game network 600, according to example embodiments of the invention.

FIG. 7 is a block diagram illustrating components of an online wagering game server, according to some embodiments of the inventive subject matter.

FIG. 8 is a flow diagram illustrating operations for presenting online wagering games with live in-casino media, according to embodiments of the inventive subject matter.

FIG. 9 is a conceptual diagram illustrating a wagering game machine used to facilitate attendant participation in online wagering games.

FIG. 10 shows a media stream in which online wagering game content is superimposed on a wagering game machine's green screens.

FIG. 11 shows an attendant selecting, on a green screen, a screen area corresponding to a game element.

FIG. 12 shows what an online player may see after a live attendant selects a game element associated with an online wagering game.

FIG. 13 is a flow diagram illustrating operations for processing a game element selection by a live attendant in a casino.

FIG. 14 is a flow diagram illustrating operations for using input from a live casino with online wagering games.

FIG. 15 shows a wagering game machine, according to some embodiments of the inventive subject matter.

### DESCRIPTION OF THE EMBODIMENTS

### Introduction

This section provides an introduction to some embodiments of the invention.

Typically, casinos offer wagering games in a variety of forms, including table games (e.g., roulette, blackjack, etc.), wagering game machines (e.g., slots, video poker, etc.), lottery-type games (e.g., keno), etc. Players often go to casinos for gaming variety and for excitement associated with live, in-person gaming. In casinos, as some players win large monetary sums, others become excited and motivated to play. As more players join-in, the casino's excitement and energy level increases. Many players believe the heightened sense of excitement enhances their gaming experience.

As an alternative to bricks-and-mortar casinos, some gaming operators offer wagering games online. For example, some gaming operators host wagering game websites that offer wagering games, such as video slots, video poker, video black jack, and more. Using such websites, players can play wagering games without going to traditional bricks-and-mortar casinos. However, some players may find online gaming to be less exciting than live, in-casino gaming. Some embodiments of the inventive subject matter bring the excitement of live, in-casino gaming to online gaming. Some embodiments present an online gaming interface and a live casino interface on-screen together. The online gaming interface presents and receives information for playing online games such as video poker, slots, etc. The live casino interface includes live media feeds (e.g., audio and video) showing live activities occurring at bricks-and-mortar casinos. The online gaming interface may be superimposed over the live casino interface. For example, the online gaming interface may appear as a life-like wagering game machine, while the live casino interface appears as a background. Because the live casino interface is streaming live events from real casinos, some embodiments bring the in-casino excitement to online players. That is, the live casino interface may show players celebrating big wins, playing community table games (e.g., craps), and otherwise interacting in the casino.

In order to further enhance online player experiences, some embodiments allow players to select between various media streams. In some instances, players can select media captured at different casinos. In some instances, players can select different camera views and media capture techniques. For instance, players may select media for one or more table games they want to watch. Additionally, players may select between different camera views for each of the table games. They may also select between various audio options.

These and other embodiments of the inventive subject matter are described in more detail below.

### Presenting Live Casio Content with Online Games

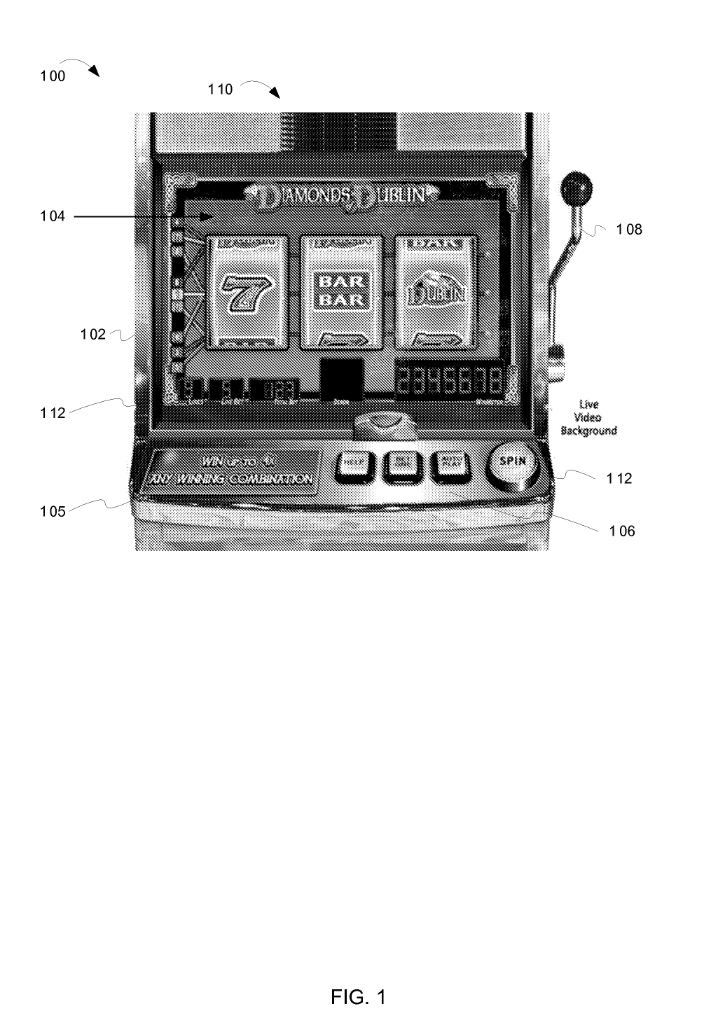

According to some embodiments of the inventive subject matter, online wagering game operators can present online wagering games along with live, in-casino content. Some embodiments present the online wagering game content in an online gaming interface, while presenting the live, in-casino content in a live casino interface. In some instances, the live casino interface serves as a background to the online gaming interface. FIGS. 1-3 show examples the online gaming interface and the live casino interface.

FIG. 1 is a conceptual diagram illustrating an online gaming interface, according to some embodiments of the inventive subject matter. In FIG. 1, an online gaming interface 100 appears as a realistic depiction of a casino-style wagering game machine 110. The graphical depiction of the casino-style wagering game machine 110 includes a cabinet 102, primary display 104, secondary display 105, button panel 106, and arm 108. In some embodiments, the casino-style wagering game machine 110 may appear as though it is a live feed of a real-life wagering game machine. However, embodiments can produce such lifelike images using any suitable computer graphics technologies, such as texture mapping.

In FIG. 1, the casino-style wagering game machine's primary display 104 serves as the primary area for presenting online games. For example, for an online slots game, graphical game elements representing the slot reels appear in the primary display 104. Thus, if a player commences a slots game by activating a spin button (e.g., by mouse clicking the spin button 112), the game's spinning reels appear in the primary display 104. Meters 112 also appear in the primary display 104. Because the graphics may be very realistic, the online gaming interface 100 provides a player experience much like real casinos-style wagering game machines.

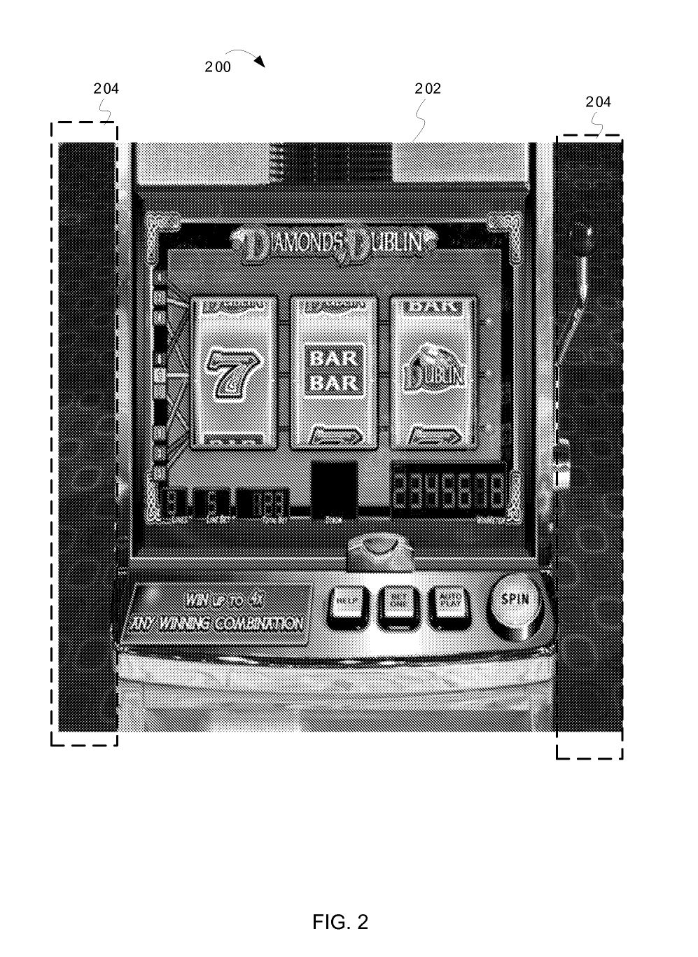

To enhance the player experience, some embodiments present a live casino interface as a background for the online gaming interface. FIG. 2 is a conceptual illustration of an online gaming interface presented with a live casino interface. In FIG. 2, a graphical user interface 200 includes an online gaming interface 202 and a live casino interface. As shown, the live casino interface appears as a backdrop to the online gaming interface. In FIG. 2, the live casino interface appears in boxes 204. The live casino interface shows a video content from live media feed captured in a real-life casino. The media feed can include audio content, video content, and data content (e.g., news, casino information, etc.) In FIG. 2, the live casino interface shows a portion of a casino floor. In FIG. 2, the live media feed merely shows carpeting of an unoccupied casino floor. However, other live media feeds may show various casino activities, such as people walking about, people playing live table games, people shopping, etc.

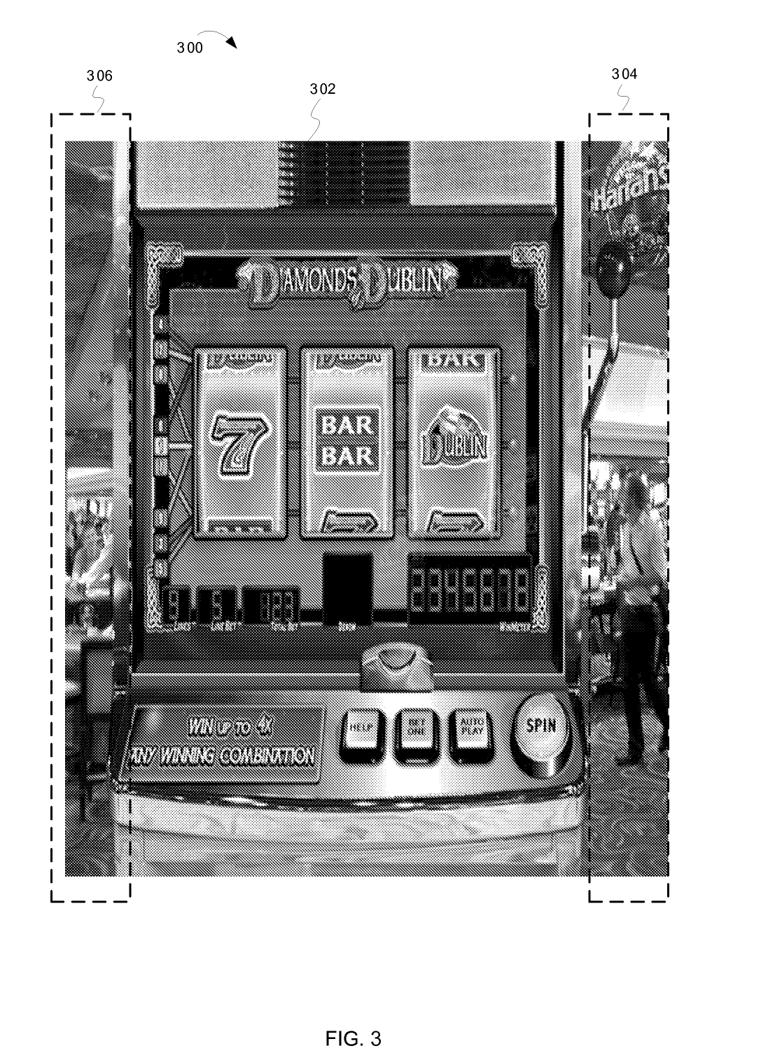

As noted, a live media feed may capture people moving about a casino. FIG. 3 is a conceptual illustration in which a live casino interface includes media showing people moving about a casino. In FIG. 3, a graphical user face 300 includes an online gaming interface 302 and a live casino interface. As shown, the online gaming interface 302 appears in the foreground, while the live casino interface appears as background content (see boxes 304 and 306). In the box 304, the live casino interface presents media showing a man walking across a real-life casino floor. Gaming machines and other casino decor are also visible. In the box 306, the live casino interface presents media showing a player at a real-life table game.

As players are playing online wagering games in the online gaming interface, they can watch and hear live casino activities in the live casino interface. In some instances, the media feeds are more detailed, so online players can see specific casino activities, such as players playing particular table games. Some embodiments facilitate more detailed views of casino activities.

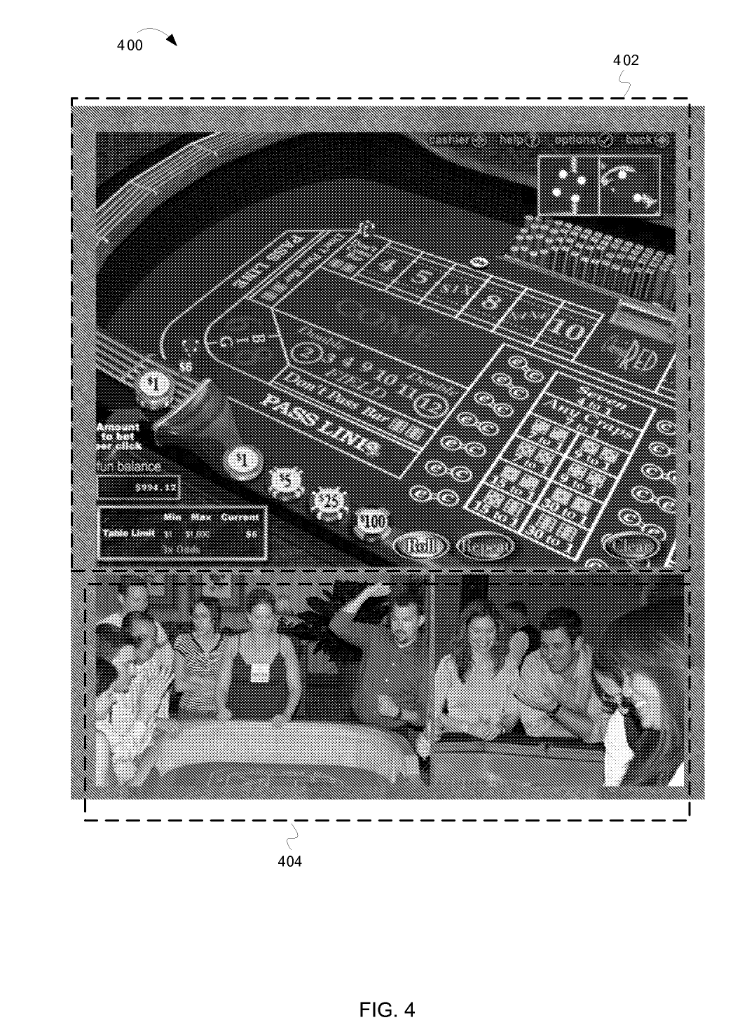

FIG. 4 is a conceptual diagram illustrating multiple views for the online gaming interface and live casino. In FIG. 4, a graphical user interface 400 includes an online gaming interface 402, and a live casino interface 404. The online gaming interface 402 shows an online craps game being played by online players. In some embodiments, the online interface portrays the online game using very realistic graphics. Such realistic graphics may make online players feel like they are playing in a live casino. In FIG. 4, this feeling may be enhanced by the live casino interface, which is streaming media showing live players at a craps table in a real casino. The live casino interface 404 shows two different views of live play at a craps table in a real casino. In some embodiments, there can be any suitable number of views and tables. In some embodiments, the online gaming interface and live casino interface both show the same game type. For example, if the online game is craps, the live casino interface shows a live media stream showing players playing craps at a real casino.

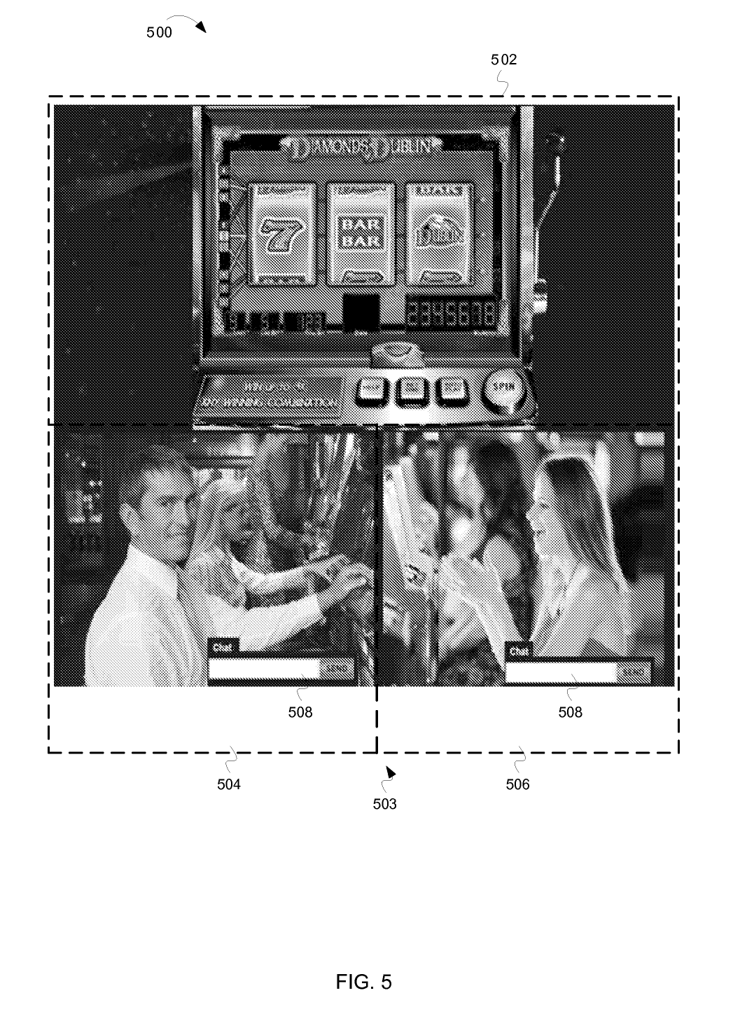

FIG. 5 shows yet another embodiment in which the online gaming interface presents multiple views of players in a live casino. In FIG. 5, a graphical user interface 500 includes an online gaming interface 502, and a live casino interface 503. The online gaming interface 502 shows an online slots game being played by online players. The live casino interface 503 includes two views (504 and 506). The view 504 presents a live media feed showing a particular player at a particular bank of slot machines in a real casino. The view 506 present a live media feeds showing a different player at a different bank in the casino. As shown, each of the views 504 and 506 includes a chat bar 508 to facilitate electronic conversations between online players and players in the casino. There is a corresponding chat facility on the slots games, table games, etc., in the casino.

The casinos may be equipped with multiple cameras and microphones for capturing multiple live media streams. In some embodiments, players can select cameras from which to receive live media streams. Therefore, some embodiments enable players to select whichever media streams they find most interesting. In some embodiments, the system can automatically select media streams for the player. For example, the system may alternate between media streams that show players winning at games similar to the online game. Furthermore, some embodiments can capture and present media streams from different casinos. Thus, for example, in FIG. 5, the view 504 can present a live media stream captured in a first casino, whereas the view 506 can present a live media stream captured in a second casino.

Some embodiments connect online players to in-casino players by electronically linking online players with players at smart tables. Smart tables are gaming tables that include electronic components for facilitating table games. For example, a smart craps table may include components for detecting bets made by particular players. The smart craps table may track betting by requiring all players to place bets via a keyboard/mouse (or other input device). Alternatively, the smart craps table may be equipped with computer vision that can track betting. Regardless of the tracking method, smart tables keep track of bets made by players. In some embodiments, if an online player has selected a live feed of players at a smart table, the system may provide various awards or benefits to line players. For example, the system may provide a win multiplier to online players who make bets identical to players at the smart table in a casino. Furthermore, the system may facilitate communications (text, voice, or otherwise) between online players and players at smart tables.

### Operating Environment

This section describes an example operating environment and presents structural aspects of some embodiments. This section includes discussion wagering game networks, and other components that may be included in some embodiments of the inventive subject matter.

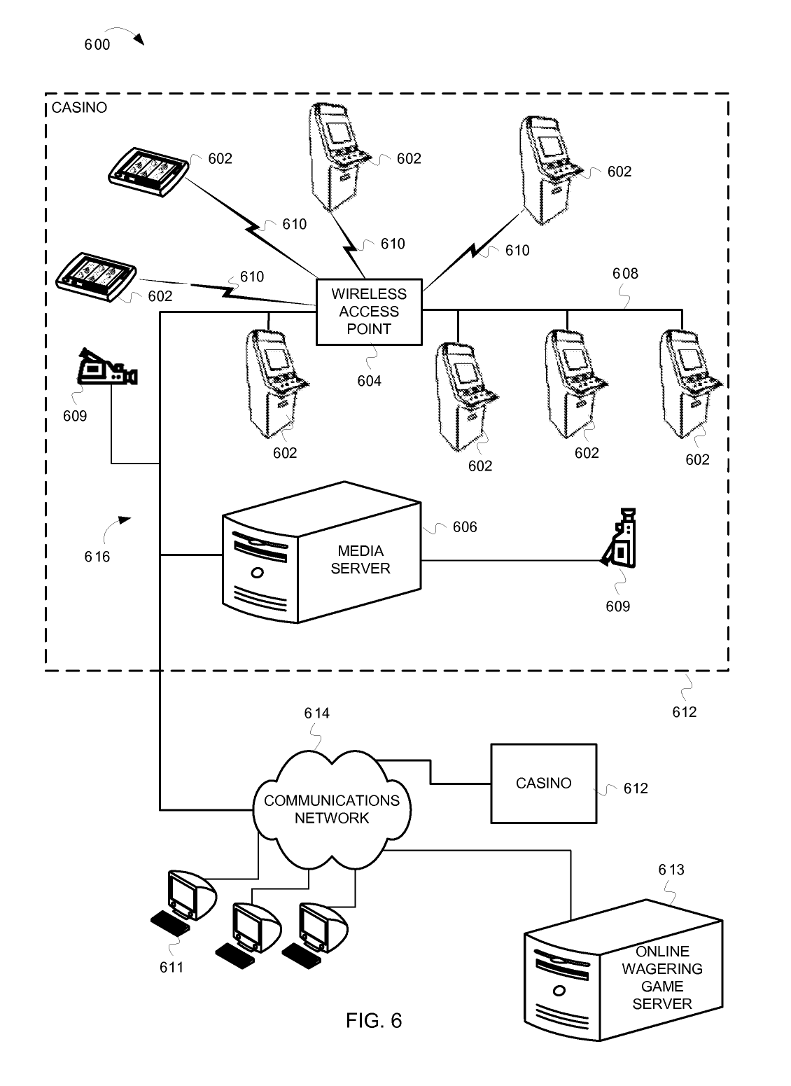

FIG. 6 is a block diagram illustrating a wagering game network 600, according to example embodiments of the invention. As shown in FIG. 6, the wagering game network 600 includes online wagering game server 613 and a plurality of casinos 612 connected to a communications network 614.

The online wagering game server 613 can host wagering games, such as video slots, video roulette, video poker, video black jack, etc. Players can use the personal computing devices 611 to play the wagering games over the communications network 614. In some embodiments, the online wagering game server 613 hosts a website that conducts the wagering games, and players play the games via the Internet.

As described above, the online wagering game server 613 can present a graphical user interface including an online gaming interface that presents online wagering games, along with a live casino interface showing live media streams from casinos. Thus, in some embodiments, the online wagering game server 613 receives media streams from the media server 606. The online wagering game server 613 can process the media streams, and incorporate them into any suitable graphical user interface, as described herein. In some embodiments, the personal computing devices 611 include local components that present the aforementioned interfaces based on media streams and data received from the online wagering game server 613 and/or the media server 606. The media streams can include video data, audio data, text data, and other information.

Each of the casinos 612 includes a local area network 616, which includes an access point 604 and wagering game machines 602. Although not shown, the casinos can also include wagering game servers that determine and record results of wagering games appearing on the wagering game machines 602. The wagering game servers may also distribute wagering game content to devices located in other casinos or at other locations on the communications network 614. The access point 604 provides wireless communication links 610 and wired communication links 608. The wired and wireless communication links can employ any suitable connection technology, such as Bluetooth, 802.11, Ethernet, public switched telephone networks, SONET, etc.

The media server 606 is connected to cameras 609 via the local area network 616. Although not shown, the media server 606 may also be connected to microphones and other audio and/or video equipment. The cameras 609 can include microphones, so they can capture audio and video streams inside the casino. The camera 609 and any other suitable media capture equipment (e.g., cameras and microphones mounted in wagering game machines) can feed media streams to the media server 606. In turn, the media server 606 can transmit media streams to other devices, such as the online wagering game server 613, and the personal computer devices 611. As described above, the live, in-casino media streams can be incorporated into live casino interfaces, as described herein.

The wagering game machines 602 described herein can take any suitable form, such as floor standing models, handheld mobile units, bartop models, workstation-type console models, etc. Further, the wagering game machines 602 can be primarily dedicated for use in conducting wagering games, or can include non-dedicated devices, such as mobile phones, personal digital assistants, personal computers, etc. In one embodiment, the wagering game network 600 can include other network devices, such as accounting servers, wide area progressive servers, player tracking servers, and/or other devices suitable for use in connection with embodiments of the invention.

In some embodiments, the personal computing devices 611 and online wagering game server 606 work together such that the personal computing devices 611 can be operated as a thin, thick, or intermediate client. For example, one or more elements of game play may be controlled by components residing on the personal computing devices 611 (client) or by the online wagering game server 613 (server). Game play elements can include executable game code, lookup tables, configuration files, game outcome, audio or visual representations of the game, game assets, etc. In a thin-client example, the server 613 can perform functions such as determining game outcome or managing assets, while the devices 611 can present a graphical representation of such outcome or asset modification to the user (e.g., player). In a thick-client example, the devices 611 can determine game outcomes and communicate the outcomes to the server 613 for recording and/or managing a player accounts.

In some embodiments, either the devices 611 (client) or the online wagering game server 613 can provide functionality that is not directly related to game play. For example, account transactions and account rules may be managed centrally (e.g., by the online wagering game server 613) or locally (e.g., by components residing on the personal computing devices 611). Other functionality not directly related to game play may include power management, presentation of advertising, software or firmware updates, system quality or security checks, etc.

Any of the wagering game network components can include hardware and machine-readable storage devices including instructions for performing the operations described herein. Machine-readable storage devices can include semiconductor memory devices, magnetic storage devices, optical storage devices, and any other device suitable for storing data.

This discussion will continue with additional details about embodiments of the online wagering game server.

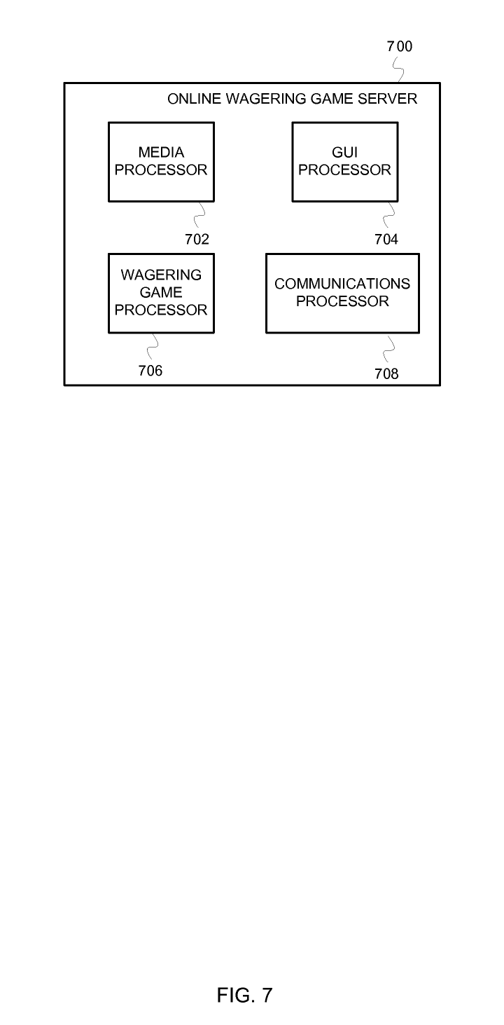

FIG. 7 is a block diagram illustrating components of an online wagering game server, according to some embodiments of the inventive subject matter. As shown, the online wagering game server 700 includes a media processor 702, GUI processor 704, wagering game processor 706, and communications processor 708. The media processor 702 can receive live media feeds from media servers or other devices configured to capture live media streams in casinos. The media processor 702 can work in concert with the GUI processor 704 to create content for live casino interfaces. The GUI processor 704 can also cooperate with the wagering game processor 706 to create content for online gaming interfaces. The online wagering game server's communications processor 708 can transmit the interface content to remote devices.

This discussion will continue with a description of operations performed by some embodiments of the inventive subject matter.

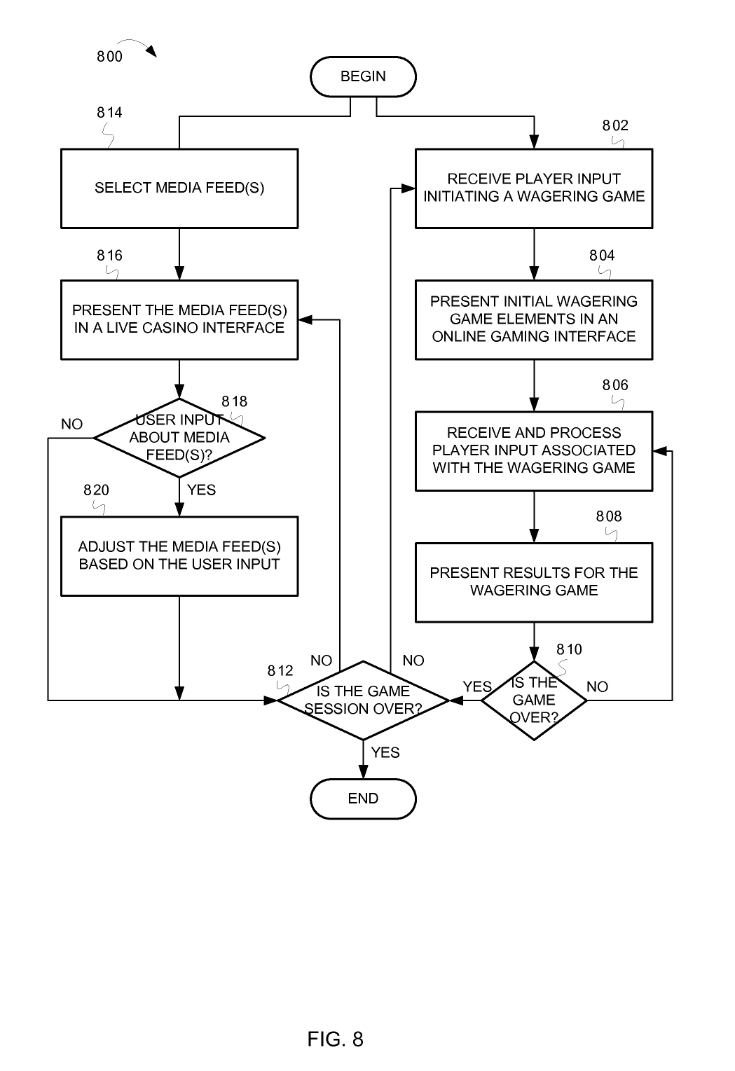

FIG. 8 is a flow diagram illustrating operations for presenting online wagering games with live in-casino media, according to embodiments of the inventive subject matter. The operations in FIG. 8 will be described with reference to components shown in FIG. 7. In FIG. 8, the flow 800 begins in parallel at block 802 and 814. The path beginning at 814 recites operations for processing media, whereas the path beginning at block 802 recites operations for processing wagering game content. This discussion will first describe the path beginning at block 814 (media operations).

At block 814, the media processor 702 selects one or more media feeds. As described above, the media feeds can include audio and/or video captured in casinos. In some instances, the media feeds show players playing group table games (e.g., craps), slots games, shopping, and/or engaging any other casino activities. In some embodiments the media processor selects a media feed that shows a live casino game similar to an online wagering game being contemporaneously presented. For example, if a player is playing online slots, the media processor may select a media feed showing slots players in a casino. As shown in FIGS. 4 and 5, the media processor may select a plurality of media feeds for incorporation into a live casino interface. The media feeds may originate at any suitable number of casinos. The flow continues at block 816.

At block 816, the GUI processor 704 presents the one or more media feeds in a live casino interface (e.g., see FIGS. 2-5). As described above, the GUI processor 700 for may show the live casino interface in concert with an online gaming interface. In some instances, the live casino interface appears as a background to the online gaming interface. As a result, players can play online wagering games, while sensing in-casino excitement via the live casino interface. The flow continues at block 818.

In some instances, users can affect the media feeds. For example, an administrator may override a selection made at block 814. Alternatively, some embodiments may allow players to select and/or control the media feeds. For example, certain game results may award players a chance to select or just media feeds. Using the award, the player may select one of a group of available media feeds. Alternatively, players may use the award to adjust audio and/or video settings of a media feed (e.g., microphone directionality, camera directionality, etc.). The operation at block 818 determines whether the system has receive user input about the media feeds. If no user input has been received, the flow continues at block 822. Otherwise, the flow continues at block 820.

At block 820, the media processor 702 adjusts the media feed based on the user input. As noted, the user input may indicate a media feed selection. In such case, the media processor selects a media feed based on the user input. However, if the input indicates a change to camera directionality or other media settings, the media processor sends a request to an appropriate media server 606. In turn, the media server adjusts the media settings. The flow continues at block 812, where the wagering game processor determines whether the gaming session is over. If the session is over, the flow ends. Otherwise, the flow continues at block 816.

This discussion will now refer to the path beginning at block 802. At block 802, the wagering game processor 706 receives player input initiating a wagering game (e.g., slots, video poker, video black Jack, etc.). The flow continues at block 804.

At block 804, the GUI processor 704 presents initial wagering game elements in an online gaming interface. For example, the GUI processor transmits information for presenting an initial card hand for a video poker game. In some embodiments, components on a client device (e.g., a personal computing device 611) assist in presenting the wagering game elements in the online gaming interface. The flow continues at block 806.

At block 806, the wagering game processor 706 receives and processes player input associated with the wagering game. For example, the wagering game processor receives and processes discard requests for a video poker game. As part of the processing, the wagering game processor may determine intermediate or final results for the wagering game. The flow continues at block 808.

At block 808, the GUI processor 704 presents intermediate or final results for the wagering game. For a video poker game, the GUI processor may present new cards to a player, in response to the discard requests. The flow continues at block 810.

At block 810, the wagering game processor determines whether the game is over. If the game is over, the flow continues at block 812. Otherwise, the flow continues operations for presenting a wagering game (at block 806). As noted above, at block 812, if the gaming session is over, the flow ends. Furthermore, if the gaming session is not over, the flow begins processing a new wagering game at block 804.

### Attendant Participation

In a typical picking bonus game, an online player must select one or more game elements. After the selection, the system determines a result for the bonus game (e.g., free spin, monetary award, etc.). In contrast to typical picking bonus games, some embodiments enable a live attendant (e.g., game attendant, casino cocktail server, casino patron, or other live person), instead of an online player, to pick game elements that may affect bonus game results. To facilitate live attendant participation, some embodiments capture a live feed of a real-life wagering game machine that is presenting green screens on its display devices. The live attendant can select an area of the green screen to simulate selection of a particular game element. In turn, embodiments can superimpose online game content over the green screens to make the live feed appear as though the live attendant selected a game element of an online wagering game. The system can use the live attendant's simulated game element selection for numerous different games running contemporaneously online. For example, the attendant's selection may make a first player's slots game have multiplier effect, while also making a second player's video poker card become wild.

Casinos can incorporate live attendant participation into online games in many ways. For example, if an online player selects a media stream capturing a particular wagering game machine that receives input from an attendant or other live person, the player's online games can receive input. In some instances, the player does not know whether the live person will provide input. That is, in some instances, the live attendant may provide input for an online game, and in other instances the attendant does not provide input. As a result, players may feel anticipation when they see an attendant approaching a wagering game machine configured to provide input for online games.

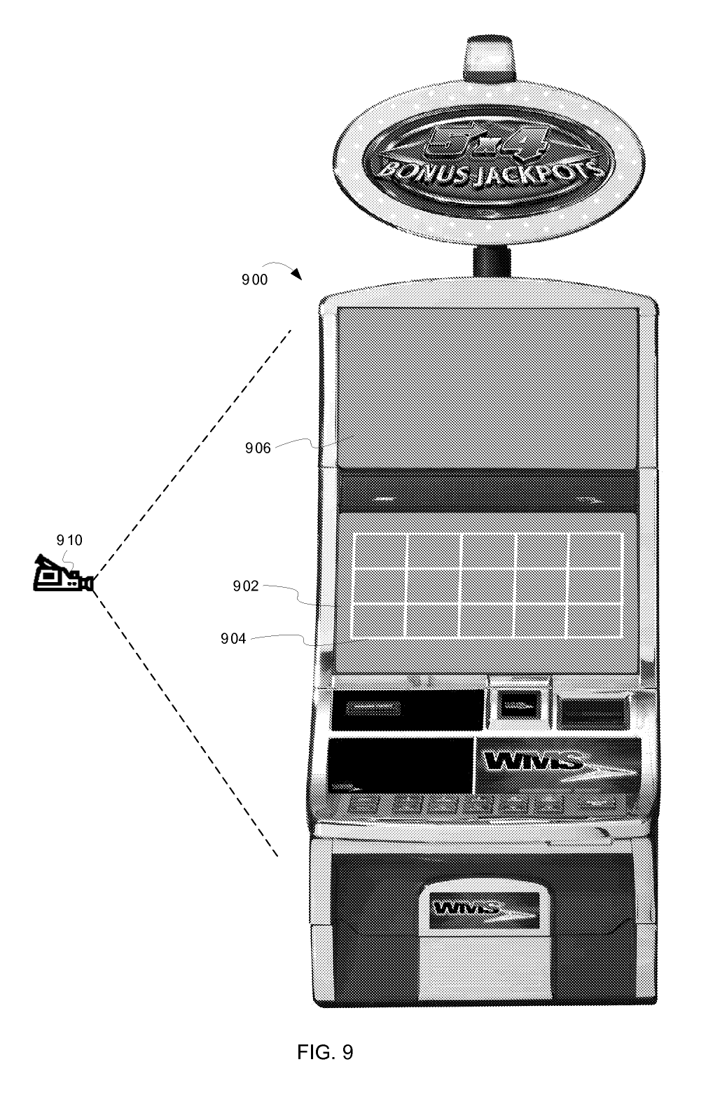

The following discussion of FIGS. 9-14 show how some embodiments enable live casino attendants to participate in online wagering games.

FIG. 9 is a conceptual diagram illustrating a wagering game machine used to facilitate attendant participation in online wagering games. A live casino can include a wagering game machine 900. The wagering game machine 900 can include all components of a typical wagering game machine, such as button panel, ticket reader, card reader, bill validator, display devices, etc. However, instead of presenting typical wagering game content on its display device 902, the wagering game machine 900 presents a green screen on its display device 902. The green screen can include a grid 904 corresponding to wagering game elements (e.g., slots symbols, video cards, etc.). The wagering game machine 900 can also show a green screen on a secondary display device 906. The green screens facilitate presentation of other graphics in the green screen areas, as described in more detail below.

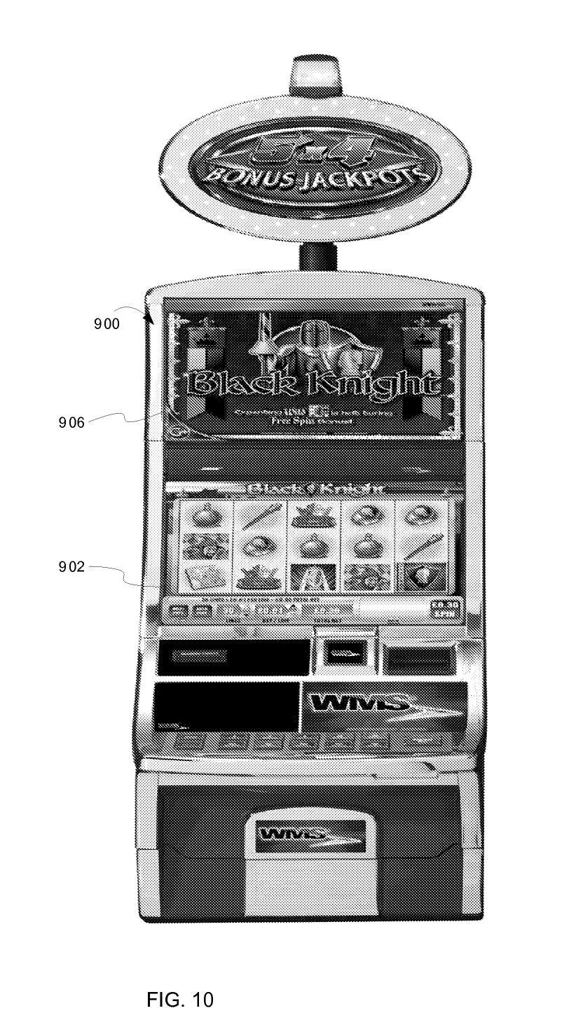

The camera 910 can capture a live feed of the wagering game machine 900 and a live attendant (not shown). A media server can forward the live feed to an online wagering game server (e.g., see FIG. 6). Because the display devices 902 and 906 present green screens, the online wagering game server can use graphical techniques to superimpose different online wagering games over the green screens. FIG. 10 shows what online players may see after the online wagering game server superimposes, in the media feed, content for a particular online wagering game onto the green areas (i.e., the display devices 902 and 906).

FIG. 10 shows a media stream in which online wagering game content is superimposed on a wagering game machine's green screens. FIG. 10 shows what an online player may see when viewing a live media feed of the wagering game machine 900. In some embodiments, the content superimposed on the wagering game machine 900 is identical to the content for the player's online wagering game. That is, in some embodiments, the live feed appears to present the online game on the real-life wagering game machine.

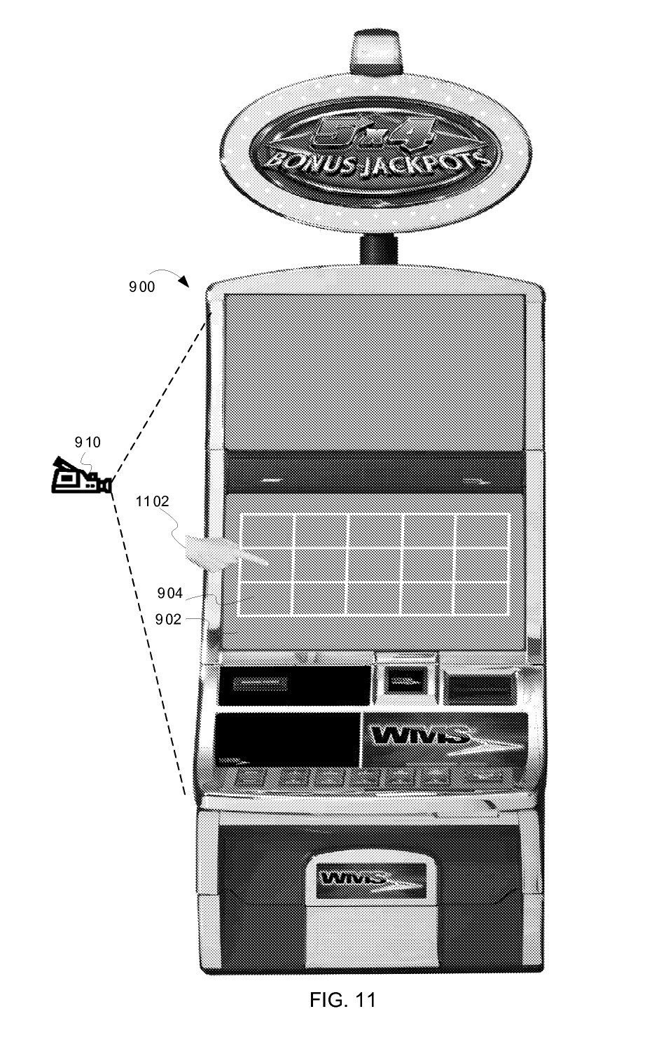

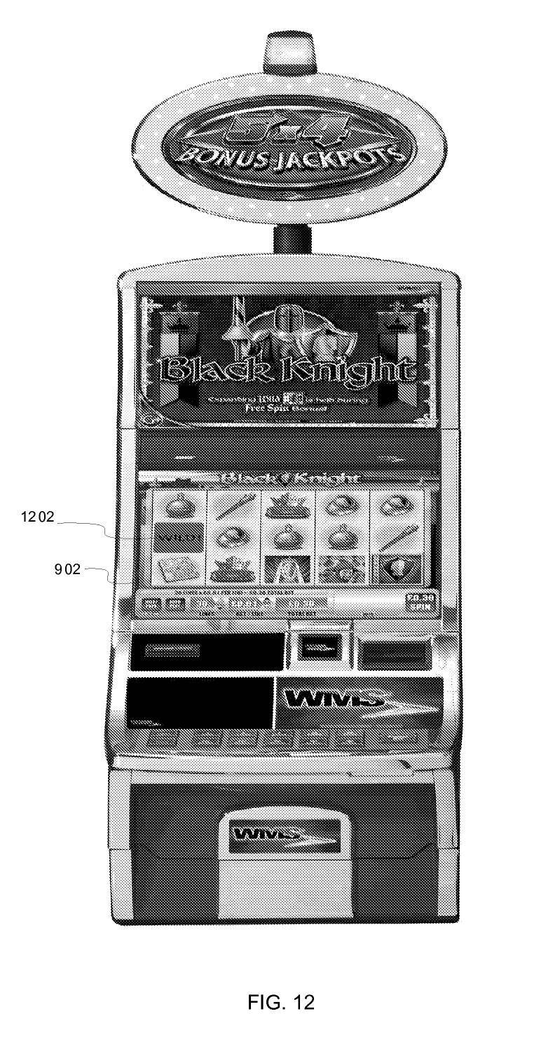

If a picking event arises, such as via a bonus game, the online wagering game server can present a live feed in which an attendant picks a game element that may affect game results. FIG. 11 shows an attendant selecting, on a green screen, a screen area corresponding to a game element. As shown in FIG. 11, the wagering game machine 900 is presenting green screens on the display devices 902. There may be a grid 904 on the display device 902, where the grid corresponds to selectable game elements. An attendant 1102 selects an area in the grid 904 to simulate selection of a game element. After the attendant 1102 makes a selection, the online wagering game server presents the selection in context of an online wagering game. As noted above, the online wagering game server can use the selection for a plurality of online games, where some of the online games are of different types (e.g., poker, slots, craps, etc.). FIG. 12 shows what an online player may see after a live attendant selects a game element associated with an online wagering game. In FIG. 12, as a result of the live attendant's selection, the online wagering game makes a game element “wild”, where the game element was occupying an area selected by the live attendant. As a result, a live game attendant can participate in online wagering games. In some cases, the selection can affect game results (e.g., the selected game element becomes “wild” and affects game results). In other cases, the selection may appear to affect results, but actually does not affect the results. That is, the live attendant's selection may merely trigger a random number generator to determine a result.

In some embodiments, the live media feed showing the attendant appears in one window, whereas the online wagering game appears in another window. The windows may appear as picture-in-picture or any other suitable arrangement.

Because online players can play a wide variety of wagering games, the online wagering game server can superimpose different content for each online player. That is, the live attendant selections can be used contemporaneously with any number of game themes (e.g., movie theme, sports theme, etc.) and game types.

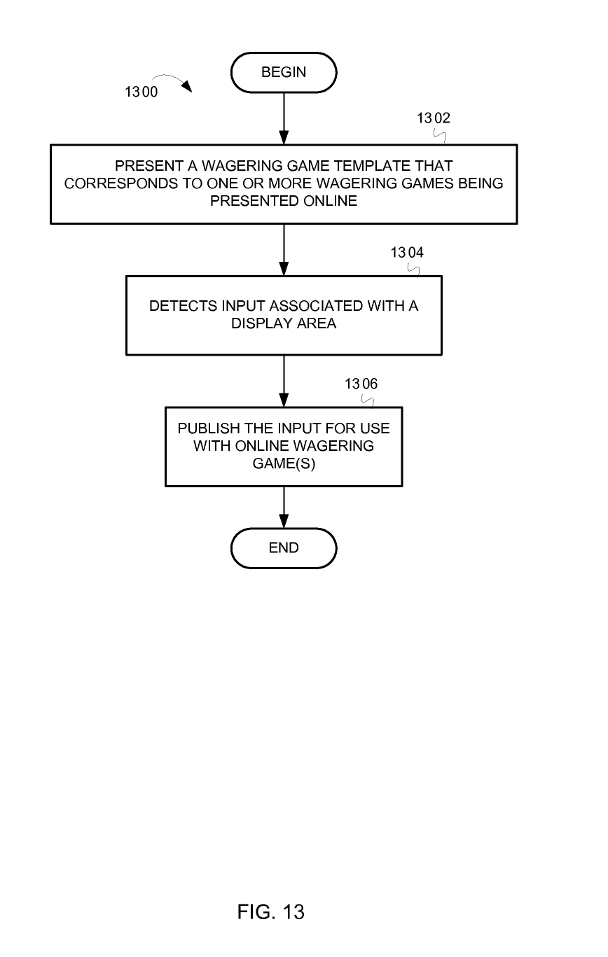

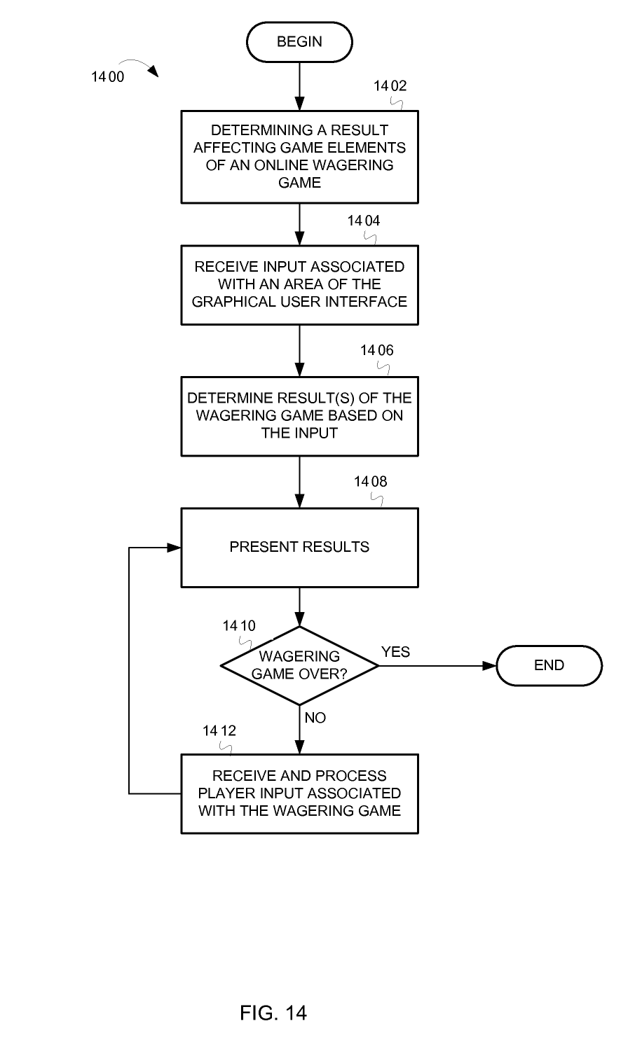

The following discussion of FIGS. 13 and 14 describe operations for facilitating live in-casino participation in online wagering games. More specifically, FIG. 13 describes operations for receiving an attendant's selection, whereas FIG. 14 describes operations for using the selection in online wagering games.

FIG. 13 is a flow diagram illustrating operations for processing a game element selection by a live attendant in a casino. The flow 1300 begins at block 1302, where a wagering game machine presents a wagering game template that corresponds to one or more online wagering games. For example, a wagering game machine can present a green screen which includes a template or grid (e.g., see FIG. 11) that corresponds to the game elements for online games. A camera can capture this presentation, and forward the content to a media server. The flow continues at block 1304.

At block 1304, the wagering game machine detects input associated area of the template. In some embodiments, the wagering game machine includes a touchscreen, which detects a screen area selection by the live attendant. As noted above, a camera can capture this selection. As a result, the media server can stream live feed including attendant selections. The flow continues at block 1306.

At block 1306, the wagering game machine publishes the input for use by online wagering games. As a result, the online wagering games can use the input as part of a process for incorporating live attendant selections into online wagering games. From block 1306, the flow ends.

After processing input indicating the attendant's selection, the system forward the input for use with online wagering games. FIG. 14 is a flow diagram illustrating operations for using input from a live casino with online wagering games. In FIG. 14, the flow begins at block 1402, where an online wagering game server determines wagering game elements for presentation in a graphical user interface. For example, an online wagering game server may select initial cards for a video poker game. Alternatively, the server may determine a position for reels in a slots game. The flow continues at block 1404.

At block 1404, the online wagering game server receives input information associated with an area of the graphical user interface. For example, the input information can include screen coordinates at which a touchscreen was touched (e.g., a touch screen on the wagering game machine's primary or secondary display devices). The screen coordinates can correspond to the online graphical user interface. As a result, the screen coordinates can correspond to a location occupied by an element of an online game, and constitute a selection of the online game element. For example, the input can select a symbol on a slot reel, a playing card, etc. In some instances, the input does not correspond to a game element, but is still relevant to an online game. For example, input associated with the wagering game machine's secondary display may trigger certain results for an online bonus game. The flow continues at block 1406.

At block 1406, the online wagering game server determines a result based on the input. In some embodiments, as noted above, the input indicates selection of an online game element. Based on the selection, the online wagering game server determines a result for the online game. Game results can be intermediate or final results. For example, the selection can determine a bonus game result (intermediate result). Alternatively, the selection can determine a final position of the game elements, such as by making a slot reel symbol wild, in a slots game. The flow continues at block 1408.

At block 1408, the online wagering game server presents the results. For example, the online wagering game server may present, in a graphical user interface for online wagering game players, a result for a picking bonus game. In other instances, the online wagering game server can present intermediate or final results for a wagering game. The flow continues at block 1410.

At block 1410, the online wagering game server determines whether the wagering game is over. If the game is not over, the flow continues at block 1412. At block 1412, the online wagering game server receives and processes player input associated with the online wagering game. From block 512, the flow continues at block 1408. Back at block 1410, if the wagering game is over, the flow ends.

The discussion of FIG. 14 does not refer to the online gaming interface and the live casino interface. However, some embodiments may present the live feed in a live casino interface, and online wagering games in an online gaming interface. These interfaces can be contained in separate windows, or they can be integrated in to form a holistic view of the online game and live feed.

### Example Wagering Game Machines

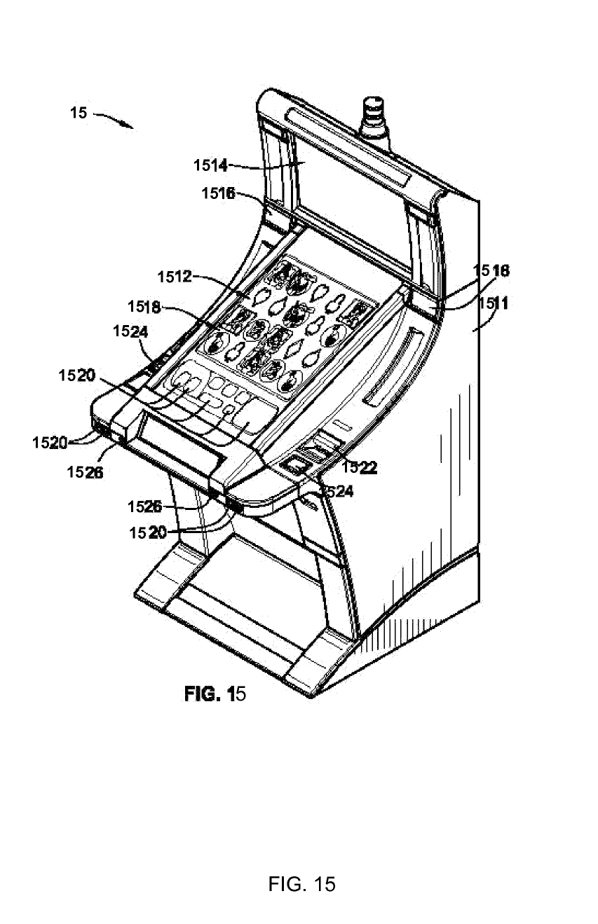

Referring to FIG. 15, there is shown a wagering game machine 1510 similar to those used in gaming establishments, such as casinos. The wagering game machine 1510 may be any type of wagering game machine and may have varying structures and methods of operation. For example, in some aspects, the wagering game machine 10 is an electromechanical wagering game machine configured to play mechanical slots, whereas in other aspects, the wagering game machine is an electronic wagering game machine configured to play a video casino game, such as slots, keno, poker, blackjack, roulette, craps, etc. The wagering game machine 1510 may take any suitable form, such as floor-standing models as shown, handheld mobile units, bartop models, workstation-type console models, etc. Further, the wagering game machine 1510 may be primarily dedicated for use in conducting wagering games, or may include non-dedicated devices, such as mobile phones, personal digital assistants, personal computers, etc.

The wagering game machine 1510 illustrated in FIG. 15 comprises a cabinet 1511 that may house various input devices, output devices, and input/output devices. By way of example, the wagering game machine 1510 includes a primary display area 1512, a secondary display area 1514, and one or more audio speakers 1516. The primary display area 1512 or the secondary display area 14 may be a mechanical-reel display, a video display, or a combination thereof in which a transmissive video display is disposed in front of the mechanical-reel display to portray a video image superimposed upon the mechanical-reel display. The display areas may variously display information associated with wagering games, non-wagering games, community games, progressives, advertisements, services, premium entertainment, text messaging, emails, alerts, announcements, broadcast information, subscription information, etc. appropriate to the particular mode(s) of operation of the wagering game machine 1510. The wagering game machine 1510 includes a touch screen(s) 1518 mounted over the primary or secondary areas, buttons 20 on a button panel, bill validator 1522, information reader/writer(s) 1524, and player-accessible port(s) 1526 (e.g., audio output jack for headphones, video headset jack, USB port, wireless transmitter/receiver, etc.). It should be understood that numerous other peripheral devices and other elements exist and are readily utilizable in any number of combinations to create various forms of a wagering game machine in accord with the present concepts.

Input devices, such as the touch screen 1518, buttons 1520, a mouse, a joystick, a gesture-sensing device, a voice-recognition device, and a virtual input device, accept player input(s) and transform the player input(s) to electronic data signals indicative of the player input(s), which correspond to an enabled feature for such input(s) at a time of activation (e.g., pressing a “Max Bet” button or soft key to indicate a player's desire to place a maximum wager to play the wagering game). The input(s), once transformed into electronic data signals, are output to a CPU for processing. The electronic data signals are selected from a group consisting essentially of an electrical current, an electrical voltage, an electrical charge, an optical signal, an optical element, a magnetic signal, and a magnetic element.

### General

For purposes of the present detailed description, the singular includes the plural and vice versa (unless specifically disclaimed); the words “and” and “or” shall be both conjunctive and disjunctive; the word “all” means “any and all”; the word “any” means “any and all”; and the word “including” means “including without limitation.”

In this document, the flow diagrams are described with reference to the block diagrams presented above. However, in some embodiments, the operations can be performed by components not described in the block diagrams. In certain embodiments, the operations can be performed by executing instructions residing on machine-readable storage devices, while in other embodiments, the operations can be performed by hardware and/or other components (e.g., firmware). In some embodiments, the operations can be performed in series, while in other embodiments, one or more of the operations can be performed in parallel. Moreover, some embodiments can perform less than all the operations shown in any flow diagram.

This detailed description refers to specific examples in the drawings and illustrations. These examples are described in sufficient detail to enable those skilled in the art to practice the inventive subject matter. These examples also serve to illustrate how the inventive subject matter can be applied to various purposes or embodiments. Other embodiments are included within the inventive subject matter, as logical, mechanical, electrical, and other changes can be made to the example embodiments described herein. Features of various embodiments described herein, however essential to the example embodiments in which they are incorporated, do not limit the inventive subject matter as a whole, and any reference to the invention, its elements, operation, and application are not limiting as a whole, but serve only to define these example embodiments. This detailed description does not, therefore, limit embodiments of the invention, which are defined only by the appended claims. Each of the embodiments described herein are contemplated as falling within the inventive subject matter, which is set forth in the following claims.

1. A method for enabling online wagering game players to receive, while playing online wagering games, live media feeds of activities in a casino, the method comprising:
presenting a graphical user interface including an online gaming interface and a live casino interface, wherein the online gaming interface includes
lifelike computer-generated images of a wagering game machine having a display device;
computer-generated images of game elements for an online wagering game, where the game elements appear on the wagering game machine's display device;
receiving a first media feed including video content portraying activities in a live casino; and
presenting the first media feed in the live casino interface.

2. The method of claim 1 further comprising:
receiving a second media feed including video content portraying additional activities in the live casino;
presenting the second media feed with the first media feed in the live casino interface.

3. The method of claim 1 further comprising:
receiving input requesting changes to perspectives of the audio and video content of the first media feed; and
receiving a second media feed including audio and video captured according to the perspectives indicated in the input.

4. The method of claim 1 further comprising:
receiving input indicating selection of the first media feed from a list of available media feeds, wherein the media feeds all include video portraying live activities in real-life casinos.

5. The method of claim 1 further comprising:
receiving input indicating selection of the first media feed from a list of available media feeds, wherein each of the media feeds includes audio and video portraying different live activities in a real-life casino.

6. An online wagering game server configured to present online wagering games and live media streams portraying activities in real-life casinos, the online wagering game server comprising:
a media processor configured to receive live media feeds including audio and video content portraying activities in a real-life casino;
a wagering game processor configured to process inputs associated with online wagering games and to determine results for the online wagering games; and
a graphical user interface processor configured to present a graphical user interface including an online gaming interface and a live casino interface, wherein the live casino interface shows the live media feeds including audio and video content portraying activities in a real-life casino, and wherein the online gaming interface shows graphical representations of the online wagering games.

7. The online wagering game server of claim 6, wherein the online gaming interface includes a lifelike graphical representation of a wagering game machine including a display device, and wherein the graphical representations of the online wagering games appear as being presented on the display device.

8. The online wagering game server of claim 7, wherein the live casino interface appears as a background to the online gaming interface.

9. The online wagering game server of claim 6, wherein the activities in the real-life casino include players playing live table games.

10. The online wagering game server of claim 6, wherein the online wagering games are table-type video games, and wherein the activities in the real-life casino include players playing live table games.

11. A method for using, in an online wagering game, input arising from a live person in a real-life casino, the method comprising:
determining a first result affecting game elements of an online wagering game;
transmitting the first result to a client device;
receiving input from a wagering game machine in a casino, wherein the input indicates selection of one or more of the game elements of the online wagering game, wherein the input arises from a live person entering the input into the wagering game machine;
determining, based on the input from the wagering game machine in the live casino, a second result for the online wagering game; and
transmitting the second result to the client device.

12. The method of claim 11, wherein the game elements are slots reels, and wherein the first result determines a non-final position of the slots reels, and wherein the second result determines a final position of the slots reels.

13. The method of claim 11 further comprising:
capturing a live media feed of the wagering game machine in the casino; and
publishing the media feed for presentation on the client device.

14. The method of claim 11 further comprising:
detecting, at the wagering game machine, the input; and
transmitting the input for use in the online wagering game.

15. The method of claim 11, wherein the second result awards money to a player.

16. A machine-readable storage device including instructions for enabling online wagering game players to receive, while playing online wagering games, live media feeds of activities in a casino, wherein when the instructions are executed by a machine, the instructions perform operations comprising:
presenting a graphical user interface including an online gaming interface and a live casino interface, wherein the online gaming interface includes
lifelike computer-generated images of a wagering game machine having a display device;
computer-generated images of game elements for an online wagering game, where the game elements appear on the wagering game machine's display device;
receiving a first media feed including video content portraying activities in a live casino; and
presenting the first media feed in the live casino interface.

17. The machine-readable storage device of claim 16 further comprising:
receiving a second media feed including audio and video content portraying additional activities in the live casino;
presenting the second media feed with the first media feed in the live casino interface.

18. The machine-readable storage device of claim 16 further comprising:
receiving input requesting changes to perspectives of the video content of the first media feed; and
receiving another media feed including audio and video captured according to the perspectives indicated in the input.

19. The machine-readable storage device of claim 16 further comprising:
receiving input indicating selection of the first media feed from a list of available media feeds, wherein the media feeds all include video portraying live activities in real-life casinos.

20. The machine-readable storage device of claim 16 further comprising:
receiving input indicating selection of the first media feed from a list of available media feeds, wherein each of the available media feeds includes video portraying different live activities in a real-life casino.

21. A machine-readable storage device including instructions for using, in an online wagering game conducted on a wagering game server, input arising from a live person in a real-life casino, wherein when the instructions are executed on a machine, the instructions cause the machine to perform operations comprising:
determining, at the online wagering game server, a first group of results affecting game elements of online wagering games, wherein the online wagering games are of different types;
transmitting, from the online wagering game server, the first group of results to client devices for presentation;
receiving input from a wagering game machine in a casino, wherein the input indicates a selection corresponding to one or more game elements of the online wagering games, wherein the input arises from a live person providing the input to the wagering game machine;
determining, based on the input from the wagering game machine in the live casino, a second group of results for the online wagering games; and
transmitting the second group of results to the client devices.

22. The machine-readable storage device of claim 21, wherein the game elements include slots reels, and wherein the second group of results includes multipliers that increase monetary awards.

23. The machine-readable storage device of claim 21, the operations further comprising:
capturing a live media feed of the wagering game machine in the casino; and
publishing the media feed for presentation on the client device.

24. The machine-readable storage device of claim 21, the operations further comprising:
detecting the input at a touchscreen of the wagering game machine; and
transmitting the input for use in the online wagering game.

25. The method of claim 21, wherein the second result awards a player money.
